(19) United States
(12) Patent Application Publication
(10) Pub. No.: US 2013/0319956 A1
(43) Pub. Date: Dec. 5, 2013

(54) APPARATUS, SYSTEM AND METHOD FOR SEPARATING SOLIDS IN SUBMERSIBLE PUMP APPLICATIONS

(71) Applicant: SUMMIT ESP, LLC, Tulsa, OK (US)

(72) Inventors: Steven Keith Tetzlaff, Owasso, OK (US); Freddie George Walton, Midland, TX (US); William Reed Sykes, Midland, TX (US); Shiv Jayaram, Houston, TX (US)

(73) Assignee: Summit ESP, LLC, Tulsa, OK (US)

(21) Appl. No.: 13/787,143

(22) Filed: Mar. 6, 2013

Related U.S. Application Data
(60) Provisional application No. 61/653,939, filed on May 31, 2012.

(51) Int. Cl. B04C 9/00

(52) U.S. Cl. CPC B04C 9/00
USPC 210/787; 210/257.1; 210/512.1

(57) ABSTRACT

An apparatus, system and method for separating solids in submersible pump applications are described. The solids separator of the invention removes solids from produced well fluid thereby reducing abrasive affects from those solids in electric submersible pump (ESP) well production applications and increasing the lifespan of the ESP assembly. A system for separating solids from produced well fluid comprises a solids separator located between an ESP pump and an ESP motor. A solids separator comprises a guide vane inducer, a cyclone configured to receive fluid from the guide vane inducer, a solids separation chamber substantially downstream of the cyclone, wherein a hard liner at least partially surrounds the solids separation chamber, a solids channel along at least a portion of the hard liner, and a solids exit located proximate the solids channel.

### CROSS REFERENCE TO RELATED APPLICATIONS

This application claims the benefit of U.S. Provisional Application No. 61/653,939 to Tetzlaff et al., filed May 31, 2012 and entitled “SOLIDS CYCLONE SEPARATOR,” which is hereby incorporated by reference in its entirety.

### BACKGROUND OF THE INVENTION

1. Field of the Invention

Embodiments of the invention described herein pertain to the field of electric submersible pumps. More particularly, but not by way of limitation, one or more embodiments of the invention enable an apparatus, system and method for separating solids in submersible pump applications.

2. Description of the Related Art

Fluid containing hydrocarbons, such as oil and natural gas, are located in underground formations. In such situations, the oil or gas must be pumped to the surface so that it can be collected, separated, refined and sold. Many of these underground formations also contain well-born solids, such as consolidated and unconsolidated sand. Induced hydraulic fracturing or hydrofracking, commonly known as fracking, may also cause solids to be deposited into well bore formations in the form of “frac” material. Whether the solids are naturally present or consist of frac material, the hydrocarbon laden fluid must pass through those solids on its way to the pump intake, and ultimately to the surface. While the pump is in operation, the hydrocarbon fluid can carry the solids through the pump components. Such well-born solids may have severe abrasive effects on the submersible pump components and increase the wear during use. Abrasive wear to the pump causes inefficiency in its operation. As a result, careful attention to solids management in submersible pump systems is needed in order to improve the production of hydrocarbon laden fluids from subsurface formations.

Currently available submersible pump systems are not appropriate for some well applications. Particularly, submersible pump systems used in oil or gas applications should be better suited to manage and reduce solids contained in well fluid. When a pump is used in an oil or gas well, produced solids can cause equipment failure, which is especially costly as this can impede well production. Replacing parts is undesirable since the equipment is deep in the ground. Care must be taken to avoid the damage caused by abrasive materials in the produced well fluid.

In the case of an electric submersible pump (ESP), a failure of the pump or any support components in the pump assembly can be catastrophic as it means a delay in well production and having to remove the pump from the well for repairs. A submersible pump system capable of removing abrasive solids from produced fluids would be an advantage in all types of submersible assemblies.

Currently available pump assemblies do not contain components to satisfactorily separate and remove solids. Such designs are not well suited to withstand excessive exposure to produced solids. These shortcomings decrease the longevity of the pump components. Therefore, there is a need for an apparatus, system and method for separating solids in electric submersible pump down-hole applications to decrease the amount of solids passing though the ESP system, thereby reducing abrasion and improving the lifespan of the pump and pump components in submersible pump applications.

### BRIEF SUMMARY OF THE INVENTION

One or more embodiments of the invention enable an apparatus, system and method for separating solids in submersible pump applications.

An apparatus, system and method for separating solids in submersible pump applications are described. The solids separator of the invention may comprise a guide vane inducer, a cyclone configured to receive fluids from the guide vane inducer, a solids separation chamber substantially downstream of the cyclone, wherein a hard liner at least partially surrounds the solids separation chamber, a solids channel running along at least a portion of the hard liner, and a solids exit located proximate the solids channel. In some embodiments, the cyclone comprises four stages of finned guide vanes keyed at 45 degrees. In certain embodiments, the solids channel spirals up the inner wall of the hard liner. In some embodiments a tapered liner at least partially surrounds the cyclone.

The method of the invention may include a method of separating solids from produced well fluid, the method comprising intaking solid laden well fluid into a solids separator, rotating the fluid as it moves downstream through the solids separator, speeding up the rotation of the fluids to separate solids, guiding the solids along a hard liner to a solids exit, and depositing the solids upstream of a solids separator fluid intake. In some embodiments, the solids are deposited using a dump tube. In certain embodiments, the fluid is rotated using an inducer. In some embodiments the fluid rotation is sped up using a series of guide vanes. In certain embodiments, the method further comprises forcing the solids outwards towards a tapered liner.

The system of the invention may include a system for separating solids from produced well fluid comprising a solids separator located between an ESP pump and an ESP motor. In some embodiments the solids separator further comprises a cyclone. In certain embodiments, the solids separator comprises an intake section and an exit section.

In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates one embodiment of an exemplary electric submersible pump (ESP) system for use in the system of the invention.

FIG. 2A is a cross section taken along line 2A-2A of FIG. 1 of one embodiment of the intake section of a solids separator of the invention.

FIG. 2B is a cross section taken along line 2B-2B of FIG. 2A of one embodiment of a top view of the cyclone of the invention.

FIG. 3 is a cross section taken along line 3-3 of FIG. 1 of one embodiment of the exit section of a solids separator of the invention.

FIG. 4 is a cross section taken along line 4-4 of FIG. 3 of one embodiment of a top view of an exemplary solids separation chamber of the invention.

FIG. 5 is a flow chart illustrating an exemplary method of separating solids from produced well fluid of the invention.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

An apparatus, system and method for separating solids from produced well fluid in submersible pump applications will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

As used in this specification and the appended claims, the singular forms “a”, “an” and “the” include plural referents unless the context clearly dictates otherwise. Thus, for example, reference to a stage of guide vanes includes one or more stages of guide vanes.

“Coupled” refers to either a direct connection or an indirect connection (e.g., at least one intervening connection) between one or more objects or components. The phrase “directly attached” means a direct connection between objects or components.

“Downstream” refers to the direction substantially with the principal flow of well fluid when the submersible pump assembly is in operation.

“Upstream” refers to the direction substantially opposite the principal flow of well fluid when the submersible pump assembly is in operation.

One or more embodiments of the invention provide an apparatus, system and method for separating solids in submersible pump applications. While the invention is described in terms of an oil or gas production embodiment, nothing herein is intended to limit the invention to that embodiment.

The invention disclosed herein includes an apparatus, system and method for separating solids from solid laden well fluid. In some embodiments, after intake into the pump assembly, the solid laden fluid may be rotated and guided downstream and/or upwards by a guide vane inducer and then passed to a cyclone. In certain embodiments, the solid laden fluid may be rotated and guided at an angle or horizontally by the guide vane inducer. The cyclone may speed up the rotation of the fluid in order to separate the solids. As the rotation speed increases, the solids may move outwards against the hard liner walls of the separator. In certain embodiments, a channel ground into the hard liner may guide the solids to an exit. The solids may then be deposited away from the pump intake. Reduction or elimination of solids from the well fluid may reduce the content of abrasive materials flowing through the pump assembly thereby allowing the assembly increased longevity. The reduction or elimination of solids from well fluid may increase the service life of the ESP assembly and reduce the producing well's downtime.

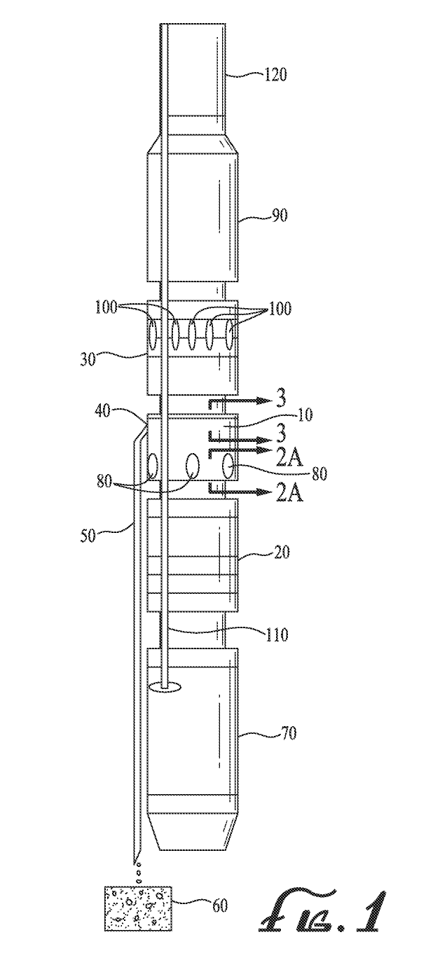

The invention includes a solids separator for electric submersible pump (ESP) systems. FIG. 1 illustrates one embodiment of an exemplary ESP assembly for use in the system of the invention. This assembly may be located in an underground well during operation. In FIG. 1, solids separator 10 is shown above (downstream) ESP seal 20 and below (upstream) gas separator 30. Gas separator 30 includes gas ports 100 and may be employed if well fluid is laden with gaseous materials. In some embodiments, gas separator 30 may not be included and solids separator 10 may sit below ESP pump 90 or an ESP charge pump (not shown). In certain embodiments, solids separator 10 may take the place of a lower tandem separator (not shown). In some embodiments, solids separator 10 may act as the sole intake surface for a pump assembly. Fluid intake 80 are shown on solids separator 10. The solids removed in solids separator 10 from produced fluid may exit the assembly at exit port 40 and travel through solids dump tube 50 to be deposited at solids deposit 60 located below ESP motor 70. Solids deposit 60 may be a catch vessel located at the lower end of ESP motor 70. Alternatively, solids deposit 60 may be positioned at any location outside the production stream, such as below and/or upstream of fluid intake 80. Motor lead extension 110 may provide power to ESP motor 70. Production tubing string 120 may carry the pumped well fluid to the surface.

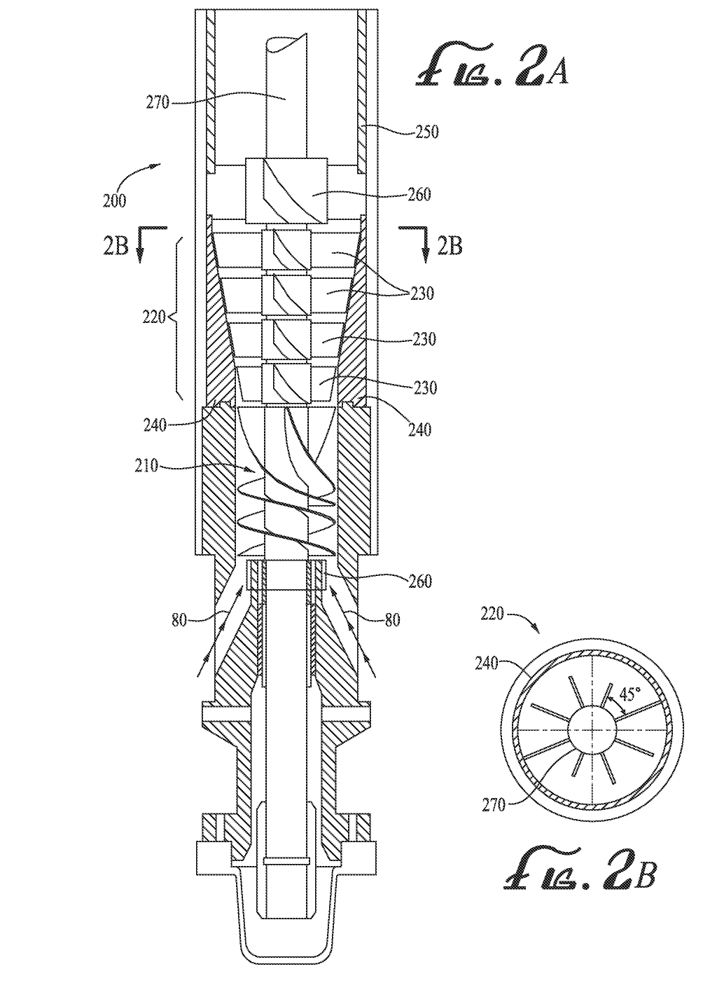

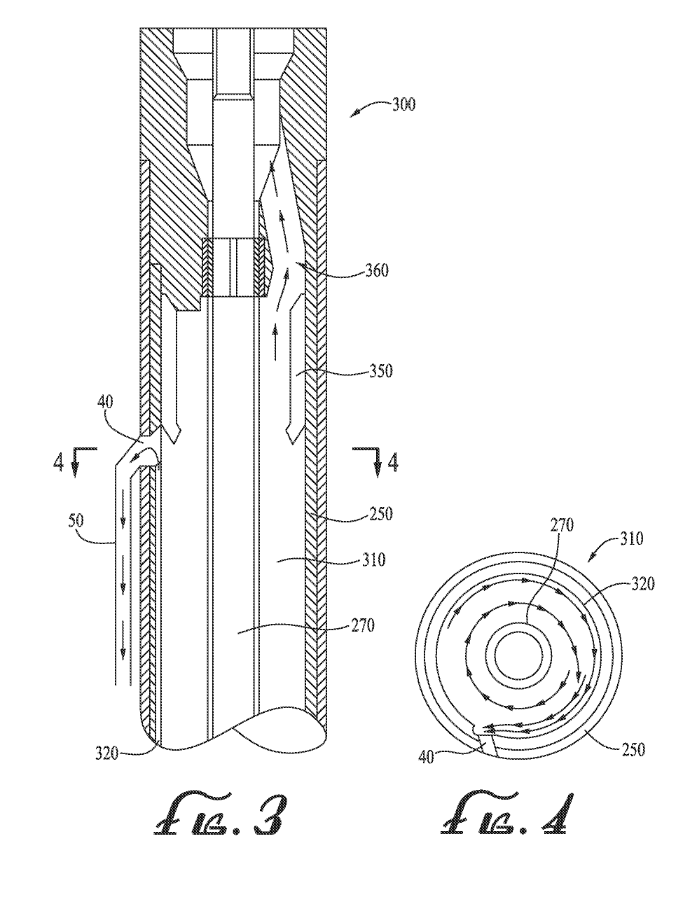

In some embodiments, a solids separator of the invention includes an intake section and an exit section. FIG. 2A illustrates one embodiment of the intake section of a solids separator of the invention. In some embodiments, intake section 200 may be the lower section of solids separator 10. In certain embodiments intake section 200 is next to, upstream of, positioned at an angle to or proximate to exit section 300 (shown in FIG. 3). As shown in FIG. 2A, produced well fluid laden with solids enters solids separator 10 at fluid intake 80. Guide vane inducer 210 may rotate with shaft 270 and guide the well fluid upwards towards cyclone 220. As shown in FIG. 2A, cyclone 220 includes four stages of rotating guide vanes 230, which also rotate with shaft 270. Other numbers of stages of rotating guide vanes 230 are also contemplated, such as one, two, three, six or eight stages. Two or more stages of guide vanes 230 may be referred to herein as a series. Stages of guide vanes 230 may be comprised of finned guide vanes, splitter vanes or any other type of guide vanes suitable for rotating fluids and guiding them upwards or in the desired direction. In certain embodiments, four stages of guide vanes 230 may be arranged at 45 degrees from one another. FIG. 2B illustrates a top view of cyclone 220 with four stages of rotating guide vanes 230 keyed at forty-five degrees from one another. In some embodiments six stages may be keyed at thirty degrees. In other embodiments, two stages may be keyed at ninety degrees. In certain embodiments, stages of guide vanes 230 may rotate freely with respect to one another. Other numbers of stages keyed at other locations are also contemplated. Cyclone 220 may speed up the rotation of the produced well materials, causing solids to move outward against tapered liner 240.

Tapered liner 240 may line a portion or all of the walls of intake section 200 that surround cyclone 220. In some embodiments, multiple layers of tapered liner 240 may be nested within one another. As shown in FIG. 2A, tapered liner 240 is thickest at the upstream portion of cyclone 220 and becomes thinner towards the downstream portion of cyclone 220. In some embodiments, tapered liner 240 may nested within the wall of solids separator 10. In some embodiments, tapered liner 240 may be of uniform thickness. In certain embodiments, tapered liner 240 may be thicker at the downstream portion of cyclone 220 and thinner at the upstream portion of cyclone 220, or in any other shape to provide the desired protection to the wall of solids separator 10 and/or guide solids in the desired direction. Hard liner 250 provides further protection from solids and is shown in FIG. 2A above abrasion resistant bearing set 260. Hard liner 250 may be tapered or untapered. In some embodiments, tapered liner 240 is hard liner 250. In certain embodiments, tapered liner 240 is distinct from hard liner 250.

Tapered liner 240 and hard liner 250 may be composed of any material or combination of materials that are harder than the produced solids. For example, tapered liner 240 and/or hard liner 250 may be made out of ceramic, or metal such as stainless steel or carbon steel, that has been ceramic coated. In some embodiments, a heat treated version of any of the above-mentioned materials may be used. In some embodiments, if a softer material is used, diffusion alloy coatings, flame sprayed coatings and plasma type coatings may be applied to the softer material in order to make its surface harder than the produced solids. In certain embodiments carbide compositions such as tungsten, silicon or titanium may be used in a solid cast type condition or as a coating applied to another surface substrate.

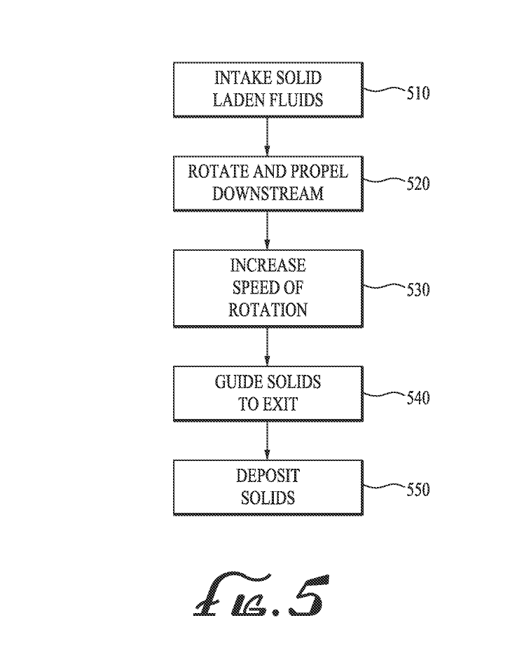

FIG. 3 illustrates one embodiment of the exit section of a solids separator of the invention, such as solid separator 10. In some embodiments, exit section 300 is located directly above and/or downstream of intake portion 200. In other embodiments exit section 300 is located horizontal, at an angle or proximate to intake portion 200. Solids may continue to move downstream in solids separation chamber 310. Hard liner 250 lines a portion or all of the walls of solids separation chamber 310. Hard liner 250 may be tapered or untapered. As shown in FIG. 3, solids channel 320 guides the solids towards exit port 40. Solids channel 320 may be etched into hard liner 250 and/or the wall of solids separation chamber 310. Solids channel 320 may be straight or may spiral along the inner wall of hard liner 250 of exit section 300, solids separation chamber 310 and/or intake section 200. FIG. 4 illustrates a top view of one embodiment of solids channel 320 running axially through the length of solids separation chamber 310.

Solids continue to move away from the pump intake via dump tube 50. Dump tube 50 may deposit the solids at solid deposit 60 (shown in FIG. 1) or at any other location away from fluid intake 80. Once solids have been reduced or eliminated from the produced materials, well fluid exits by way of fluid diverter 350 and well fluid exit 360. Well fluid may then continue through gas separator 30 or ESP pump 90. The fluids passing through ESP pump 90 may then have reduced solid content and eventually proceed to the surface above-ground.

The shape, width and depth of solids channel 320 may vary based on the type of solids encountered during fluid and the surface area, size and/or shape of hard liner 250 and/or solids separation chamber 310. For example, solid channel 320 may be straight, angled, slanted, spiral shaped, curved, shallow, deep, wide or narrow. In certain embodiments, solids channel 320 may have a depth of 0.100, 0.200 or 0.500 inches and a width of 0.100, 0.200 or 0.500 inches. In other embodiments, shallower or deeper or narrow or wider solids channels 320 may be desirable depending on the type of solids encountered and/or the surface area, size and/or shape of solids separation chamber 310 and/or hard liner 250.

In some embodiments, solids channel 320 may be included during the casting process and then finish ground. In certain embodiments, solids channel 320 may be ground in place as part of the finishing process. Electrical discharge machining (EDM), such as sinker EDM, may also be used to add solids channel 320 when great precision is desirable. The various methods of manufacturing are well known to those of skill in the art and may depend upon factors such as the particular shape or size of the solids channel and hard liner 250.

FIG. 5 is a flow chart illustrating an exemplary method of separating solids from produced well fluid. At intake step 510, solid laden well fluid enters the ESP assembly such as through fluid intake 80. The fluid may then be rotated and propelled downstream or towards cyclone 220 at rotating step 520. In some embodiments, guide vane inducer 210 assists in imparting downstream rotating motion to the solid laden fluid. The speed of rotation of the solid laden fluids is increased at step 530. In some embodiments, the speed of rotation is increased by cyclone 220. In some embodiments, the increase in speed pushes solids radially outwards against the walls of tapered liner 240, thereby separating at least some of the solids from the fluid. At step 540, solids are guided to an exit, such as exit port 40, thereby leaving solids separator 10. At step 550, the removed solids are deposited away from fluid intake 80, such as at solids deposit 60, and therefore do not pass through the remainder of the ESP pump assembly, reducing wear on the pump assembly and thereby increasing its lifespan. In some embodiments, dump tube 50 assists in depositing solids away from fluid intake 80.

The apparatus, system and method for separating solids of the invention may be suitable for a variety of types of submersible stages known in the art for use in submersible pumps. For example, mixed flow submersible pump stages, as well as radial flow submersible pump stages, may make use of the apparatus, system and method for separating solids of the invention. Both these and other submersible stages suitable for use with an ESP assembly may benefit from the apparatus, system and method for separating solids of the invention.

While the invention herein disclosed has been described by means of specific embodiments and applications thereof, numerous modifications and variations could be made thereto by those skilled in the art without departing from the scope of the invention set forth in the claims. The foregoing description is therefore considered in all respects to be illustrative and not restrictive. The scope of the invention is indicated by the appended claims, and all changes that come within the meaning and range of equivalents thereof are intended to be embraced therein.

What is claimed is:

1. A solids separator for a submersible pump assembly, the separator comprising:
a guide vane inducer;
a cyclone configured to receive fluid from the guide vane inducer;
a solids separation chamber substantially downstream of the cyclone, wherein a hard liner at least partially surrounds the solids separation chamber;
a solids channel along at least a portion of the hard liner; and
a solids exit located proximate the solids channel.

2. The solids separator of claim 1, wherein the cyclone comprises a stage of guide vane.

3. The solids separator of claim 1, wherein the cyclone comprises four stages of finned guide vanes keyed at 45 degrees.

4. The solid separator of claim 1, wherein the solids channel is straight and runs axially along the hard liner.

5. The solids separator of claim 1, wherein the solids channel spirals up the inner wall of the hard liner.

6. The solids separator of claim 1, wherein the cyclone is located substantially downstream of the guide vane inducer.

7. The solids separator of claim 1, wherein the solids exit is located substantially downstream of the cyclone.

8. The solids separator of claim 1, further comprising a fluid intake at least partially upstream of the inducer guide vane.

9. The solids separator of claim 1, further comprising a fluid diverter and well fluid exit located downstream of the solids exit.

10. The solids separator of claim 1, further comprising an abrasion resistant bearing set located upstream of the inducer guide vane.

11. The solids separator of claim 1, wherein a tapered liner at least partially surrounds the cyclone.

12. The solids separator of claim 11, wherein the tapered liner is the hard liner.

13. The solids separator of claim 1, further comprising dump tube mechanically coupled to the solids exit.

14. A system for separating solids from produced well fluid comprising a solids separator located between an ESP pump and an ESP motor.

15. The system of claim 14, wherein the solids separator further comprises a cyclone and a solids exit.

16. The system of claim 15, wherein the cyclone further comprises a stage of guide vane.

17. The system of claim 14, wherein the solids separator further comprises a fluid intake.

18. The system of claim 14, wherein the solids separator further comprises an intake section and an exit section.

19. A method of separating solids from produced well fluid, the method comprising:
intaking solid laden well fluid into an electric submersible pump (ESP) solids separator;
rotating the fluid as it moves downstream through the solids separator;
increasing the speed of rotation of the fluid to separate solids;
guiding the solids along a hard liner to a solids exit; and
depositing the solids upstream of a solids separator fluid intake.

20. The method of claim 19, wherein the solids are deposited using a dump tube.

21. The method of claim 19, wherein the fluid is rotated using an inducer.

22. The method of claim 19, wherein the fluids are sped up using a series of guide vanes inside a tapered liner.

23. The method of claim 19, further comprising the step of forcing the solids radially outwards towards the hard liner.

24. The method of claim 19, wherein the solids are guided along the hard liner using a solids channel.
